(19) United States
(12) Patent Application Publication
(10) Pub. No.: US 2006/0290519 A1
(43) Pub. Date: Dec. 28, 2006

(54) Two-way wireless monitoring system and method

(76) Inventors: Alan R. Boate, Ottawa (CA); David S. Ozsvari, Ottawa (CA)

Correspondence Address: TEITELBAUM & MACLEAN, 1187 BANK STREET, SUITE 201, OTTAWA, ON, K1S 3X7, CA

(21) Appl. No.: 11/472,341

(22) Filed: Jun. 22, 2006

Related U.S. Application Data
(60) Provisional application No. 60/692,562, filed on Jun. 22, 2005.

(51) Int. Cl. G08B 23/00

(52) U.S. Cl. 340/573.4

(57) ABSTRACT

A two-way wireless monitoring system tracks the location of badged users or objects within a facility, and accordingly provides a variety of services relevant to the badge location and ID. The system comprises a plurality of beacons bearing beacon IDs distributed throughout the facility, a portable badge having a badge address, a base-station having access to a central unit via a data network. Each beacon periodically broadcasts the respective beacon ID, for being picked up by the badge when being nearby. The base-station polls the badge to receive the beacon IDs of the nearby beacons, and then uploads such beacon IDs to the central unit via the data network. Finally, the central unit estimates the badge location and decides on triggering an event within the facility based on the estimated badge location.

### CROSS-REFERENCE TO RELATED APPLICATIONS

This application claims priority from U.S. Provisional Patent Application No. 60/692,562 filed on Jun. 22, 2005, which is incorporated herein by reference.

### TECHNICAL FIELD

The present invention relates to systems and methods for wireless monitoring of badged users and objects within an area, and in particular to two-way systems and methods for triggering specific events within a facility.

### BACKGROUND TO THE INVENTION

There are a multitude of prior applications in computing and telecommunication, which alter their behavior depending on the location of a user or a moveable object. For example, the Active Badge system, developed by Olivetti Research between 1989 and 1992, provides a portable device (tag) worn by personnel, transmitting a unique IR (infrared) signal every 10 seconds. Each office or point of interest within a building is equipped with one or more fixed IR sensors used in determining the location of the portable device. In this system, a tag concealed from visibility (in a pocket, or just out of sight from the sensor) completely disappears from the system, and is not acceptable for security applications.

To overcome the loss of visibility of the portable device, Radomsky, et al disclose in U.S. Pat. No. 6,574,482 a dual RF/IR (Infrared/Radio Frequency) portable device, wherein an RF transmitter mounted in conjunction with an IR transmitter on the portable device to transmit IR and RF (radio signals to one of a plurality of fixed readers, each having an IR and RF receiver, and typically being mounted in a respective enclosed space, such as a room. IR transmissions from the portable device are detected by the IR receiver of the reader in the same room and thus provide an immediate identification of the room wherein the portable device is located. In case the IR transmitter in the portable device is concealed or for any other reason is not within line-of-sight of the reader in its immediate proximity, then the RF signal transmitted by the RF transmitter in the portable device is detected by the RF receiver in the reader to maintain tracking of the portable device.

Another example is the location system disclosed in U.S. Pat. Nos. 6,211,790 and 6,753,781 by Radomsky et al for providing infant security. In this system, a dual-mode IR/RF transmitter is secured within a wristband worn by the mother and within an ankle and/or wristband worn by the infant. In a matching mode of operation, IR signals are received by infrared receivers located within the various rooms of the hospital to precisely and automatically determine by proximity that mother and infant are correctly united. In a presence detecting mode, RF signals from the infant's badge are detected by RF receivers located throughout the maternity ward of the hospital or throughout the hospital generally. In a security mode, RF receivers located at proximate exits of either of the maternity ward and/or the hospital detect RF signals from the ankle and provide a signal to generate an alarm.

Nevertheless, in any system requiring a one-way transmitting portable device (tag) such as the above, battery power is a scarce resource in the portable device, providing only limited power of the IR or RF transmission. Thus, sensitivity of the fixed receiver is crucial, which requires an expensive sensor, expensively networked to each room or point of interest.

In their University of Leipzig publication dated February 2003, Tom Pfeifer, Dirk Elias describe a local positioning system with dynamic granularity, using a hybrid IR/RF technology fitting into a suite of distributed Smart IP devices within a scalable and flexible architecture. However, such a transmit-only one-way system does not present a way of adapting to density of tags and may therefore suffer a dramatic reduction in efficiency with increasing density. Another problem is the large volume of data flowing into the fixed readers from all the tags. Furthermore, one-way systems need to make multiple transmissions in an attempt to ensure that an important message gets through.

There is therefore a need for an affordable solution for a situation for a relatively large number of coverage areas (office/meeting rooms, multiple points of interest in exhibitions,), perhaps of a similar order of magnitude as number of persons and objects to be tracked. In particular, hospitals and other healthcare institutions accommodate a variety of staff personnel, patients and equipment, each having different roles and requiring different privileges.

An object of the present invention is to provide an economical system designed to obtain an estimation of the location of people and equipment. Another object of the present invention is to use this estimation for making the access to facilities and computer systems more secure, reliable, convenient, for allowing context driven applications, and for allowing hands-free voice paging and messaging within an organization.

### SUMMARY OF THE INVENTION

Accordingly, the present invention relates to a two-way wireless monitoring system and method for tracking the location of a badged user or a badged object within a facility

In a first aspect, the present invention provides a two-way wireless monitoring system comprising:
a plurality of beacons bearing unique beacon IDs thereof, distributed throughout the facility for periodically broadcasting over a wireless medium respective beacon messages carrying the respective beacon IDs;
a portable badge having a unique badge address for picking up from the wireless medium the beacon messages of nearby beacons;
a base-station comprising an RF transceiver for establishing an RF link with the badge when being within an RF coverage range of the base-station;
a central unit accessible by the base-station via a data network; and
a network manager for multiplexing and demultiplexing traffic between the base-station and the data network,

wherein, in operation, the badge composes a badge message containing the beacon IDs of the nearby beacons;

wherein the base-station frequently polls, via the established RF link, the badge to receive the badge message therefrom;

wherein the base-station uploads a base-station message, containing the badge address and the badge message, to the central unit via the data network; and

wherein the central unit estimates the badge location using the base-station message and decides on triggering an event within the facility based on the badge address and the estimated badge location.

The badge and the base-station are respectively assigned unique cryptographic keys for use in: (a) authenticating the badge address and the badge messages to and from the central unit; (b) encrypting transmitted messages; and (c) checking freshness and integrity of received messages.

Typically, the plurality of beacons include a radio frequency (RF) beacon and an infrared (IR) beacon, and the badge comprises means for measuring received signal strength intensity (RSSI) value of the beacon message of the RF beacon, and an IR receiver for picking the beacon messages of the IR beacon, wherein the badge message to the central unit includes the beacon ID of the RF beacon, said RSSI values, and information on changes in the IR beacons detected by the badge since sending most recent badge message. Preferably, the IR beacon comprises means for generating a power-adjusted and optically shaped broadcast envelope to define a coverage range for the IR beacon, and a light sensor for stabilizing the IR beacon coverage range by adjusting the IR beacon emission power to compensate for ambient light levels. Optionally, the IR beacon further comprises means for sequentially adjusting emission of the IR beacon to more than one power level, wherein the beacon ID is distinctly different for each power level.

The RF link includes a narrowband RF control channel and a wideband RF data channel. The badge further comprises a badge processor, and the RF badge transceiver is selectively switchable between the RF control channel and the RF data channel under control of the badge processor. In addition, the badge comprises:
a) a flash memory unit linked to the badge processor for bulk storage of received messages and messages awaiting transmission;
b) a programmable interface for transferring data between the badge processor and the RF badge transceiver; and
c) a user interface linked to the badge processor, the user interface including a component selected from the group consisting of:
   an audio codec and a speaker-microphone pair controlled thereby;
   an RFID tag reader for reading passive RFID tags;
   a piezoelectric buzzer for alerting the user;
   an LED display, for indicating status of the badge;
   a set of pushbutton switches, for activation by the user;
   a motion sensor;
   a serial I/O port; and
   a proximity sensor having single I/O pin on the badge processor for detecting proximity of a body part of the user by a change in the pin's capacitance

The base-station (BS) comprises:
a) a first transceiver for the control channel;
b) a second transceiver for the data channel;
c) a data network interface;
d) a BS processor communicating with the data network interface, the first and second transceivers;
e) a BS antenna; and
f) a SAW duplexer linked to the first and second transceivers and the BS antenna, for feeding the antenna with combined signals from the first and second transceivers, while providing mutual isolation between the first and second transceivers

In a specific application of the monitoring system, the plurality of beacons include a plurality of stationary beacons and a portable beacon for being worn by a designated person, such that the user is considered to be ‘safe’ when being in one of a ‘safe location’ defined by a specified subset of the plurality of stationary beacons, and a ‘safe custody’ defined by the portable beacon.

Optionally, the monitoring system further includes an RF tag, bearing a unique tag ID, for periodically broadcasting an RF ‘ping’ carrying the tag ID;

wherein the base-station includes a frequency-adjustable tag reader coupled to a tag antenna for receiving the ‘ping’, and means for measuring received signal strength intensity (RSSI) value of the received ‘ping’;

wherein, in operation, the base-station uploads the tag ID and the RSSI value to the central unit for use in estimating the tag location; and

wherein the tag comprises a motion sensor to increase the ping rate when motion is sensed.

In a further aspect, the present invention there provides a method for tracking the location of a badged user or a badged object within a facility. The method comprises the steps of:
(a) providing a plurality of beacons throughout the facility, each of which periodically broadcasts over a wireless medium a beacon message, carrying a corresponding beacon ID;
(b) providing a portable badge having a badge address for picking up from the wireless medium the beacon messages within the coverage area thereof, for composing a badge message containing the respective beacon IDs, and for compiling and monitoring a beacon data table of all the picked up beacons, to detect any change in the badge location;
(c) transferring the badge message to a central unit over an RF network, at a predetermined polling frequency, by a base-station; which attempts to establish a network link to the central unit, wherein the base-station is dynamically configured as a gateway when successful, and self-configured as a router when unsuccessful, and wherein the router seeks to establish the data network link via another base-station configured as a gateway;
(d) maintaining at the central unit a beacon record of location and coverage area associated with each beacon ID;
(e) performing an analysis of the received badge message against said beacon record and using the analysis estimating the badge location by the central unit; and
(f) triggering an event within the facility, based on the badge address and the estimated badge location, wherein the event is one of the group consisting of allowing a secured access to a specific area within the facility, data transfer, paging, voice and data messaging, authentication, providing infant security, and delivering local navigational guidance.

The present invention offers several advantages over prior art solutions, including the following:
The two-way system is generally more adaptive than a one-way system to increasing badge density by slowing down the rate of polling of individual badges.
The effective density of badges is possibly reduced by the ability to use multiple overlapping RF channels as permitted by the two-way system to allow adding more base-stations to a coverage area.
A more reliable message delivery service in both directions is provided by the two-way system.
The automatic logon and logoff based on proximity will allow security to be increased while actually increasing the convenience for the users and protecting patient privacy.
The badge is configured to act as an intelligent filter on the location information, by using the badge's ability to determine any movement from the previous location, to limit sending the badge message only upon movement, thereby significantly reducing the overall network traffic, particularly when badges spend relatively long periods of time in the same location.
An ability to push this data filtering out away from the central unit.
Automatic logon/logoff via IR beacon and 2 way RF communications are not based on workstation itself.
Being network based allows secure and convenient session portability when workstation is moved.
The provision of a (local) authentication prevents an attacker from spoofing a badge by just responding to polls after the real badge has left the area. For example, a ‘spoofer’ is possibly used to maintain an already active session on a workstation.

### BRIEF DESCRIPTION OF THE DRAWINGS

The invention will be described in greater detail with reference to the accompanying drawings which represent exemplary embodiments thereof, in which same reference numerals designate similar parts throughout the figures thereof, wherein:

FIG. 1 illustrates in a block diagram two-way wireless monitoring system in accordance with an embodiment of the present invention.

FIG. 1 illustrates in a schematic diagram the elements the basic and all optional components of the badge shown in FIG. 1.

FIG. 3 illustrates in a schematic diagram the elements the elements of the base-station shown in FIG. 1.

FIG. 4 illustrates in a block diagram the network configuration of the monitoring system shown in FIG. 1.

### DETAILED DESCRIPTION

Reference herein to any embodiment means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

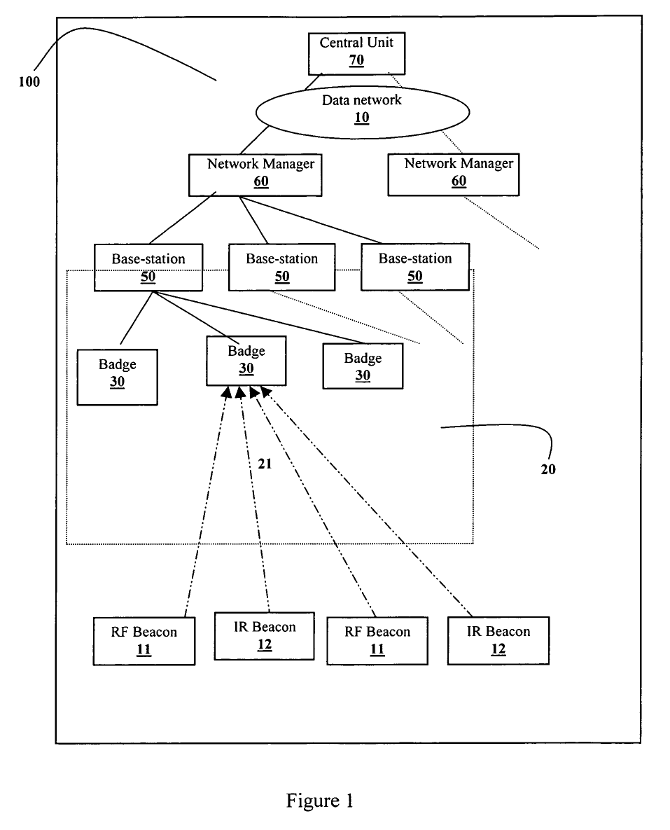

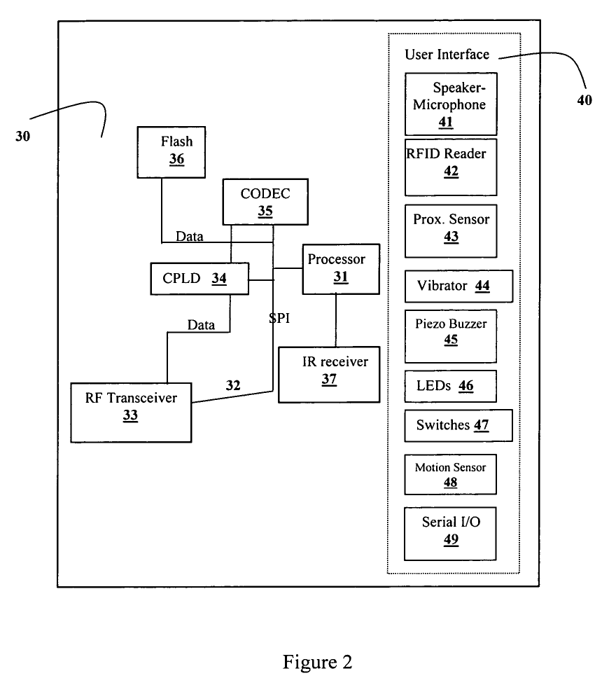

The present invention addresses the limitations of prior art systems by providing a a two-way wireless monitoring system 100 for tracking the location of badged users or objects within a facility covered by the monitoring system, and accordingly provides a variety of services relevant to the location and ID of the badges in terms of the contextual status of the monitored users or objects within the overall system. As shown in FIG. 1, the monitoring system 100 has a number of stand-alone radio frequency (RF) beacons 11 and infrared (IR) beacons 12, an RF network 20, a number of network managers 60, and a central unit 70. The RF network 20 has a number of portable badges 30 and a number of stationary base-stations 50, engaged in a secure two-way communication over RF channels at two different bit rates; a narrowband rate (e.g. 19.2 Kb/s) for control channel traffic, and a higher wideband rate (e.g. 153.6 to 500 Kb/s) for transfer of data and voice messages over a data channel. The RF channels are selected from available worldwide ISM bands such as the 900 MHz band (e.g. 920-927 MHz range for the control channel, and 902-912 MHz range for the data channel), as well as the 2.4 GHz and 5.8 GHz bands.

The control channel has a smaller bandwidth than the data channel, thereby allowing for a higher density of available control channels within a given RF spectrum.

The base-stations 50 use different frequency channels from one another to allow for overlapping base-station coverage and to allow each badge 30 to communicate with the nearest base-station 50, in a similar manner to a typical cellular phone network. The base-stations 50 are linked to the central unit 70 via the network managers 60. Typically, the central unit 70 is remotely located from the network managers 60, then a communication link is established using a data network 10, such as a standard wired or wireless IP LAN and/or WAN, to connect the base-stations 50, network managers 60 and the central unit 70. Each one of the RF beacons 11, IR beacons 12, assigned a respective unique beacon ID known to the central unit 70, which also knows the location of each RF beacon 11, RF beacon 12, and each base-station 50. Also each badge 30 has a badge address, which is mapped by the central unit 70 to a unique badge ID.

The RF beacons 11 and the IR beacons 12 periodically broadcast, over a wireless medium 21, beacon messages carrying the respective beacon IDs. Any nearby badge 30 then picks up the IR and RF beacon messages from the wireless medium 21, measures the received signal strength intensity (RSSI) of picked up RF beacon message and compiles a beacon data table of the RF beacon IDs and the corresponding RSSI values of RF beacons, and any change in IR beacons, i.e. acquiring a new IR beacon, or losing a current IR beacon. Upon being polled by the nearest base-station 50, such badge 30 then transmits a badge message, containing the compiled beacon list to the nearest base-station 50, which in turn composes a base-station message including the badge message and the badge address and uploads such base-station message via one of the network managers 60 to the central unit 70.

The central unit 70 then uses the received base-station message and the known location of the RF beacons 11 and the IR beacons 12, stored in a database therein, in obtaining an estimation of the badge location 30 within the area covered by the monitoring system 100. Based on the ID and the estimated location of the badge 30 and a set of roles and privileges pre-assigned thereto, the central unit 70 decides on triggering an event within the facility covered by the monitoring system 100 such as taking no action, allowing a secured access to a specific area within the covered facility, data transfer, paging, voice and data messaging, authentication, providing infant security, delivering local navigational guidance, etc. Having all the traffic routed via the central unit 70 allows the monitoring system 100 to perform post-facto audit of audio, paging, time-stamping of messages, keeping track of all system traffic, etc.

Each one of the badges 30 and the base-stations 50 is assigned a unique cryptographic key to be installed together with the software operating program for use in authenticating the badge addresses and the badge messages to and from the central unit 70, as well as for encrypting transmitted messages and for checking freshness and integrity of received messages. An example of the cryptographic key is a 128-bit random number, which is algorithmically unrelated to the ID of the badge 30 or the base-station 50, and which is used in the Advanced Encryption Standard (AES) algorithm.

The beacon messages of the RF beacons 11 are used for coarse location estimation by the central unit 70. This is because RF signals are able to penetrate physical barriers such as walls, partitions, fabrics, and the human body. The IR beacons 12, on the other hand, broadcast infrared signals and are used for locating services that require the estimation of well-defined location zones, such as access validation for workstation and menu logon, door entry, presence in a specific room or within a certain coverage range of the IR beacon, etc. This is because IR signals travel only through lines of sight without penetrating opaque physical barriers.

Each RF beacon 11 is programmed to operate on a single RF channel assigned in accordance with the total number of RF beacons 11 required within a given area and available RF spectrum. Such RF channel is assigned in accordance with one of the following schemes:
a) A single pre-assigned RF channel for all such RF beacons 11.
b) One RF channel at a time selected from a pre-assigned set of channels;
c) A suitable low usage channel is selected independently by RF the beacon 11 based on measured density of use of available channels.

Typically more than one RF beacon 11 is assigned with the same RF channel. To avoid mutual collisions, such assigned RF channel is shared co-operatively on a channel-friendly basis by following the ‘listen before talk’ (LBT) protocol, such that each RF beacon 11 begins to broadcast the beacon message thereof, only after a random time period following a detection of a clear (unoccupied) channel.

Each IR beacon 12 generates a broadcast envelope which is power adjusted and optically shaped by selecting an appropriate type of IR emitter (LED) and optionally using an optical lens, to suit specific applications. For instance, a workstation logon in an area populated with other adjacent workstations typically requires a relatively narrow IR beam generated by a single IR emitter having a coverage range of just 3-4 feet, to avoid overlapping with other IR emitters used for beacons associated with adjacent workstations.

The IR beacons 12 placed around doors with secure access also require tight envelopes that must be invisible to persons merely passing by to avoid an unnecessary action by the monitoring system 100 to grant door access. In contrast, the type of IR beacon 12 used to cover an entire room typically requires multiple IR emitters at higher powers to flood the room with IR radiation. The IR beacon 12 is optionally provided with a light sensor used for adjusting the IR beacon emission power to compensate for ambient light levels and to keep the IR beacon coverage range effectively constant.

To increase location resolution of the IR beacons 12 within a given room, two alternative techniques are provided in accordance with the present invention, as follows.
a) The IR beacon 12 is provided as a multi-beacon, wherein the emission power is sequentially adjusted to more than one power level, and a different beacon ID is broadcast for every power level. This allows the central unit 70 to estimate a range of distance from the IR beacon 12, based on the expectation that the badge 30, when in close proximity to an active IR multi-beacon, will receive all the IR beacon signals, and when moving farther away, will receive the strongest ones and eventually will see only the strongest beacon of all. By determining which of the IR beacons 12 the badge 30 is able to receive from the multi-beacon, and knowing the characteristic pattern for the IR envelope at each different power level, the central unit 70 then estimates a more precise range of distance from the multi-beacon, than otherwise possible with a single IR beacon. Two alternative configurations are available for the multi-beacon; a single IR emitter (LED), and multiple IR emitters with different power levels and radiation envelopes.
b) More than one single IR beacon 12 of different IDs and lower radiation power are used, and the central unit then estimates location of the badge 30 by determining which of the IR beacon IDs are received by the badge and which ones are not.

With reference to FIG. 1 each badge 30 listens to each one of the detectible beacon channels for a predetermined time period (typically 250 ms) before beginning to analyze any received beacon messages. Once the received beacon messages are analyzed, the badge 30 transmits a corresponding badge message to the central unit 70 via the nearest base-station 50 and the network manager 60 linked thereto.

FIG. 2 illustrates in a block diagram, the basic and all optional components of the badge 30. These components include a badge processor 31 communicating via an SPI badge bus 32 with an RF badge transceiver 33, a programmable interface 34, an audio codec 35, a flash memory unit 36, and a user interface 40 including a speaker-microphone pair 41, an RFID tag reader 42, a proximity sensor 43, a vibrator 44, a piezoelectric buzzer 45, an LED display 46, a set of pushbutton switches 47, a motions sensor 48, and a serial I/O port 49. The badge processor 31 is further linked to an IR receiver 37 for receiving the beacon messages of the IR beacons 12 (shown in FIG. 1). In addition, the user interface 40 is directly linked to the codec 35 and to the RF badge transceiver 33.

The badge processor 31 contains memory components (not shown) in the form of a RAM plus a flash memory for allowing installation of software programs and an EEPROM for storing local configuration data and allowing the badge 30 to maintain state during battery replacement. The badge design is simplified by having all the functions controlled from the badge processor 31.

To provide additional security functions for the badge 30 and the messages sent and received thereby, a pre-shared cryptographic (e.g. AES) key unique to the badge is to be installed together with the software operating program; thereby rendering the badge processor 31 as a self-bounded cryptographic module, useful for meeting the requirements of the FIPS 140 standard on how to handle cryptographic keys. Providing the badge 30 with verifiable authenticity using the key constitutes a preventative against potential cloning such as forging a false badge carrying an authentic badge address.

Optionally, a more powerful badge processor 31 is used, to enable the badge 30 to use Distributed Speech Recognition (DSR). With DSR, the badge 30 extracts audio features to be used for speech recognition from the sound stream of a voice message, and then sends such features to the central unit 70 for further processing. This means that the speech recognition is in effect using a high quality sound stream thereby avoiding any audio signal loss associated with compressing the sound stream on the badge for transmission over the RF network. The extraction of the features on the badge 30 also serves to compress the sound stream efficiently for transmission to the central unit 70 over the RF network. This extra processing capability also allows the badge 30 to achieve speech recognition locally for use in controlling the user interface 40 of the badge 30 along with the set of pushbutton switches 47, to facilitate setting up user preferences and user's interaction to the badge 30. The more powerful badge processor 31 will also allow running asymmetric cryptographic algorithms by using a public-private key pair instead of the symmetric key. With this, the badge 30 will be able to act as a personal private key carrier for the user, thereby simplifying the use of the key and improving the security.

The RFID tag reader 42 has a short reading range (e.g. 40 mm), for reading passive RFID tags such as standard ISO-15693 tags using 13.56 MHz. This allows the badge 30 to significantly extend the range of possible applications of the present invention, whenever the combination of a badge address and an object tagged with a passive RFID need to be fed to an application running on the central unit 70 (shown in FIG. 1) or alternatively sent to an application running on a remote computer (e.g. a clinical system).

The badge transceiver 33 is frequency-agile capable of running on any of the ISM bands used in the RF network 20 as mentioned above, and is selectively switchable between the slower rate of the control channel and the higher rate of the data channel. The badge transceiver 33 is controlled by the badge processor 31 via the badge bus 32 to receive and transmit data over the RF channel, under software controlled communication parameters (frequency, modulation, baud rate, etc.). The badge transceiver 33 listens to nearby base-stations 50 (transmitting at different RF channels), and tries to join the polling loop of the nearest one in terms of providing the strongest RSSI. The badge 30 then keeps a running average of the RSSI values of the nearest base-station 50.

Using the RF badge transceiver 33, and the IR receiver 37, the badge periodically listens to as many RF beacons 11 and IR beacons 12 as possible over a predetermined period of time, compiles the beacon data table as mentioned above, and then monitors such data table to detect any likely change in the location of the badge 30 relative to the location of the RF beacon 11 and the IR beacons 12. This detection is based on any substantial changes in the set of the received RF beacon RSSI values, reception of new beacon IDs, or timeout of old beacons. Following such detection, the badge 30 then waits for receiving a poll from the nearest base-station 50 before transmitting the badge message mentioned above, which contains a set of the beacon messages received since transmitting the previous badge message and the corresponding RSSI values of the RF beacons 11, together with beacon IDs of newly acquired and/or lost IR beacons 12. This way, network traffic is reduced at the expense of extra badge computing and memory.

The programmable interface 34 processes any bit stream received from the transceiver 33, and searches for a ‘flag’ indicating the beginning of the beacon message or the base-station message. The ‘flag’ is typically coded as ‘01111110’ (7E). Once the flag is seen, the programmable interface 34 sends an interrupt signal to the badge processor 31 and then proceeds to ‘de-stuff’ the ensuing bit-stream into bytes (as offset from the flag) to be available to the badge processor 31 over the SPI badge bus 32. The programmable interface 34 also accepts bytes of data over the badge SPI bus 32 from the badge processor 31 for sending as bits to the badge transceiver 33.

The flash memory unit 36 is used for bulk storage of messages in the badge, and is partitioned into more than one section for storing the data to recreate any ‘canned’ messages (further discussed below) and as transient storage for any voice messages received from, or to be sent to, the base-station 50.

Communication between the programmable interface 34 and the audio codec 35 is time-division multiplexed under control of the audio codec 35. This is to offload from the badge processor 31 the tasks of serialization and de-serialization, which typically require a large amount of processing when done entirely in software.

The audio codec 35 controls inputs and outputs of the speaker-microphone pair 41, and has audio filters to compensate for sampling noise in reconstructed audio signals, and for programmable gain controls. The speaker-microphone pair 41 allows transfer of voice and paging messages between the badges 30 (routed via the central unit 70), as well as between any one of the badges 30 and any applications running on the central unit 70. When a voice message is routed to the badge 30, such message will have one of a series of states including ‘waiting to send’, ‘sent’, ‘played’ and ‘acknowledged’ and this status information is maintained in a database in the central unit 70, to be made available for query at any time.

The proximity sensor 43 is mounted on the badge's front side for allowing the badge user to acknowledge the central unit message having been received from the base-station 50 and played, in order to provide guaranteed delivery. The proximity sensor 43 allows doctors and nurses to respond to a message without breaching sterilization procedures, as it allows responses to be indicated using a chin, an elbow, or any other convenient means of responding. One simple form of the proximity sensor 43 is a single I/O pin on the badge processor 31 which detects the proximity of a part of the user's body by a change in the pin's capacitance, to be measured by pin's voltage after a short time delay (in a few microseconds) following electric charging of the pin. The sensitivity of such a device is adjustable by varying the time delay. Self-calibration of the proximity sensor 43 is achievable with a software instruction, typically on boot-up after a battery replacement.

The vibrator 44 is used to indicate reception of any pages, voice messages and other alerts, when the badge 30 is placed into a silent (mute) mode. A high priority override is provided in the software program to allow high-priority alerts (such as fire) to override the silent mode. The buzzer 45 is used for simple badges such as equipment badges in lieu of the speaker-microphone pair 41. The LED display 46 is for indicating the badge status. The set of pushbutton switches 47 are for user interaction. As an example one of the pushbutton switches 47 is used as an alarm (or panic) button, by which a user evokes the central unit 70 to trigger an alarm event and to send a response to the badge 30 such as a confirmation tone or a ‘canned’ voice message. The motion sensor 48 serves any one of a number of different purposes, e.g. for saving on battery life by going to a sleep mode when the badge 30 is stationary, for remote monitoring of body position of a patient wearing the badge 30, and for controlling the badge's rate of response to base-station polls, with a higher rate when the badge 30 is in motion and a lower rate when stationary. Exemplary forms of the motion sensor 48 include MEMS two-axis and three-axis accelerometers.

It is to be noted that the badge 30 shown in FIG. 2 incorporates all the features described herein, not all of which are necessarily required for every badge within the monitoring system 100, depending on the types of services provided to the badge carrier, such as staff, patients, visitors, infants, equipment, etc.

There are two types of voice and paging messages transferred from the badge 30 to the base-station 50; (a) indices of sound samples for playback, which are already stored (‘canned’) on the badge, and (b) compressed voice messages. The canned messages are relatively short and are transferred over the control channel along with all other data messages. The canned messages are optionally played in more than one language, by having canned message vocabularies in different languages stored in the flash memory unit 36. Thus, the canned message is spoken in one or more languages preferred by the intended recipient. The compressed voice messages are inherently long and are transferred via one of the data channels dedicated temporarily to such transfer, in order to avoid interfering with regular activities of the base-station 50.

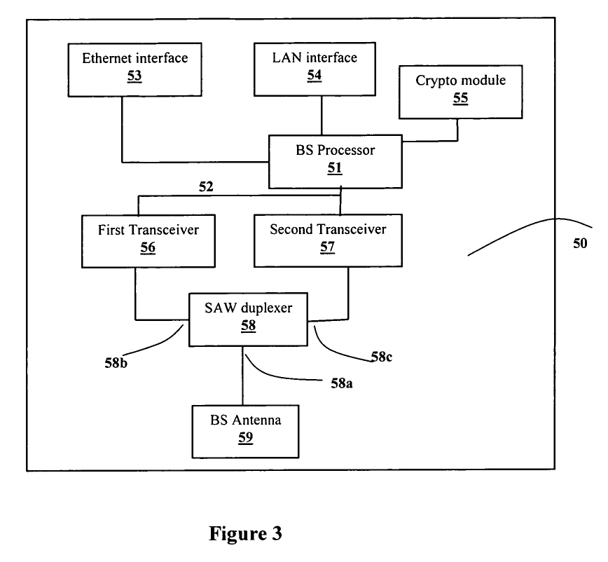

As shown in FIG. 3, the base-station 50 has a BS processor 51 communicating via an internal BS bus 52 with data network interfaces, including an Ethernet interface 53 and a LAN interface 54. The base-station 50 also includes a cryptographic module 55, a first transceiver 56 for the control channel, and a second transceiver 57 for the data channel. Both the first and second transceivers 56 and 57 are linked to a BS antenna 59 via a SAW duplexer 58 for combining signals from both the transceivers 56 and 57, while isolating the two transceivers 56 and 57 from one another. The duplexer 58 has a common port 58a connected to the BS antenna 59, a high-pass port 58b connected to the first transceiver 56, and a low-pass port 58c connected to the second transceiver 57. Under this configuration, a signal from any one of the two transceivers 56 and 57 is routed to the antenna 59 on the common port 58a, while being blocked from the other transceiver due to the filtering action of the duplexer 58, thereby allowing the two transceivers to operate simultaneously but separately with minimal mutual interference. Using the same antenna 59 relies on the frequency isolation obtained with using separate RF bands for data and control channels while ensuring similar antenna patterns associated with both BS transceivers.

Each of the first and second transceivers 56 and 57 is under complete software control from the BS processor 51 via the BS bus 52, to configure frequency, modulation, baud rate etc. and to regulate transmission power levels to be in line with standard ISM power-level and field strength constraints.

The BS processor 51 contains a network software layer, and looks after low-level protocol and raw data processing from the first and second transceivers 56 and 57 respectively. The BS processor 51 has on-chip memory components (not shown) in the form of a RAM, an EEPROM for storing local configuration data for the control channel, an external SRAM memory used for data buffering, and a flash memory, which is protected from external inspection by hiding the code and data therein, to allow for installation of a cryptographic key with the program thereby providing secure functioning of the base-station processor 51.

The cryptographic module 55 is a self-contained device that carries out cryptographic functions such as authentication and encryption. To ensure security of the base-station functions, a cryptographic key is installed with a software program and protected from external access; thus the processor with the on-board protected memory thereof becomes a self-bounded cryptographic module, useful for meeting the requirements of the FIPS 140 standard. The cryptographic module 55 has memory-read protection, such that any cryptographic key information written to the module will not be retrievable.

The Ethernet interface 54 is built to comply with an existing Ethernet standards such as 10/100BaseT depending on chosen external components. The Ethernet interface 54 logically connects to a TCP/IP stack in the BS processor 51 and provides network connectivity.

Commercial transceivers are available for implementing each of the badge transceiver and the first and second transceivers in the base-station such as the Chipcon CC1020 transceiver as presented in http://www.chipcon.com. Such commercial transceivers, however, use a crystal for providing a frequency reference, which is vulnerable to changes in temperature. In order to stabilize the frequency over the transceiver's anticipated working temperature range (−20° C. to +40° C.), a digital temperature sensor is optionally used to correct for any frequency drifts, by comparing the sensed temperature against a stored crystal calibration setting.

The base-station 50 is designed to provide a relatively close range of coverage (˜10 to 20 m). Lower power levels and lower ranges are used to obtain more efficient channel re-use schemes, and longer battery life on the badges.

The base-station 50 uses a non-slotted polling protocol for the control channel, wherein each badge 30 is polled explicitly by a local address thereby giving the base-station full discretion as to polling order and frequency. The protocol is dictated by the central unit 70 and defines different polling rates for different badges according the specific roles and privileges assigned to each badge. This protocol supports automatic load balancing to equalize base-stations' workloads thereby offering an optimum compromise between latency and bandwidth utilization that degrades gracefully as the load increases to very high levels, wherein the addressing limitation per each base-station is 200 badges and 50 routers.

Each network manager 60 (shown in FIG. 1) is a small computer running as an appliance, for multiplexing and demultiplexing traffic between the base-stations and the central unit. The network manager 60 is typically required for a remote building or location. More than one network manager 60 is normally required for a relatively large facility, for different logical and physical network segments. The Network Manager 60 joins the central unit 70 as a slave, after a mutual authentication process is successfully completed.

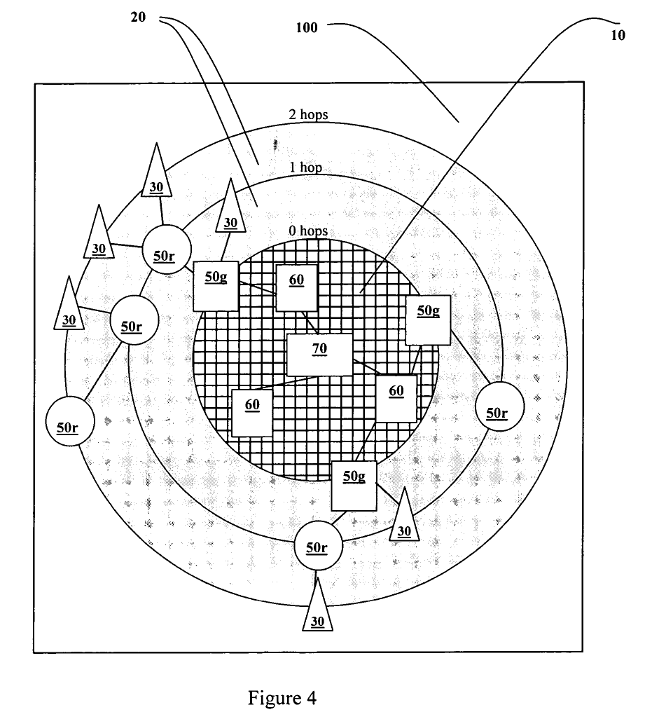

As shown in FIG. 4, each base-station 50 is capable of being dynamically configured as either a gateway 50g or a router 50r, to allow the monitoring system 100 to provide fault tolerance by allowing the RF network 20 to reconfigure and bypass those network managers 60 and gateways 50g, which fail to connect to the data network. This way, the configuration of the RF network 20 emerges as a series of concentric circles. Under this configuration, each gateway 50g has as designated slaves, the badges 30 and routers 50r transmitting thereto, and each router 50r has as designated slaves, the badges 30 and routers 50r transmitting thereto. Each base-station (router 50r and gateway 50g) continuously sends polls addressed to each slave thereof, which only transmits the messages thereof upon receiving such poll.

Under such configuration, the base-station 50 attempts to connect to the central unit 70 via a standard LAN link of the data network 10 by seeking one of the network managers 60. To do this the base-station 50 broadcasts a query to the network managers 60, and waits for a response, which indicates the number of slaves currently served by the responding network manager 60, and identifies a pair of ports thereof, one for connecting the base-station 50 as a client and another for the network manager 60 to connect back. The base-station 50 then decides which of the responding network managers 60 to join, based on the number of existing slaves, thereby providing a degree of load balancing to the RF network 20. Once a successful connection is established between the base-station 50 and one of the responding network managers 60, the central unit 70 then sends a configuration packet to configure the base-station 50 to function as a gateway 50g with channel information for selecting suitable control and data channels. Upon receiving the configuration packet, the configured gateway 50g is ready to function as a master and starts looking for slaves in the form of badges 30 and other routers 50r.

In case of a failure to connect with one of the network managers 60, the base-station 50 will be self-configured as router 50r and will use one of the RF network frequencies to begin looking for one of the already connected gateways 50g to join as a slave.

The central unit 70 handles all communications to and from all the badges 30 via the RF network 20 and the network managers 60, and has a record for every beacon ID indicating the location of the corresponding beacon, the area covered thereby and the parameters that affect the beacon's signal strength such as transmit power level, antenna, etc. The central unit 70 periodically receives the base-station messages for analysis against a database of known areas covered by every RF beacon 11, IR beacon 12 and base-station 50 to estimate the location of the badge 30, based on one of conventional approaches such as triangulation or trilateration. The central unit 70 then stores the estimated location in a badge location table available for other applications to use. The estimated location is maintained by the central unit 70 and is updated every time the location of the badge 30 changes.

In the case that an IR beacon 12 has been physically moved, the central unit 70 checks the received base-station messages relevant to the IR beacon 12 against those relevant to the RF beacons 11 to note any inconsistencies and act accordingly. For instance, if the location estimation based on the IR beacon 12 indicates that the badge 30 is in room A, whereas the location estimation based on the RF beacons 11 indicate that the badge is in room C, an inconsistency is noted and reported for attention to check if the IR beacon 12 has been moved in an unauthorised fashion.

There are two kinds of location estimations possible with the present invention:
1) Physical location defining a set of coordinates on a map. Such location estimation results directly from the reported RSSI values of the RF beacons 11 and the base-station 50, which when combined with the respective known locations of these RF beacons 11 and base-stations 50 stored in the central database, allow the central unit 70 to use a conventional method like trilateration or center-of-gravity to determine the approximate location of the badge. In such methods, the precision of the location estimation depends mainly on how many RF beacons 11 are deployed; the larger the number (and corresponding cost), the higher the precision. This provides flexibility in system design for trading precision with cost.
2) Symbolic location defining an abstract location, e.g. a named room or a numbered floor in a given building. Such location estimation results directly from an association between a room and the IR beacon 12 reported by the badge 30, as the coverage range of the IR beacon 12 does not extend beyond the room in which it is placed.
   (See Hightower and Borriello, Location Systems for Ubiquitous Computing; IEEE Computer Society Journal, August 2001.)

The monitoring system 100 is also able to interconvert between physical and symbolic locations using a hierarchy of elements (e.g. rooms, floors, wings, buildings, etc.) and knowing where these elements are located on the physical map. In the central database, the RF beacons 11 are associated with an (x,y)-location on a map whereas the IR beacons 11 are associated with an element in the location hierarchy.

Considering the above, a hierarchy of priority in estimating the badge location will be as follows.

i. Symbolic Location by the IR beacons 12:

a) IR multi-beacons with multiple IR emitters. In case information from two IR beacons is reported wherein the coverage range of one is contained within that of another having a larger coverage range area, then information from the former IR beacon takes precedence, thus establishing a hierarchy of precision;
   b) Room IR beacons;
c) Physical access IR beacons (optional); and
d) Workstation IR beacons (optional).
   ii. Physical location using reported RF beacons:
a) At least two reported RF beacons, wherein the location is estimated using the respective RSSI values and a standard estimation method such as trilateration or center of gravity.
b) Only one reported RF beacon, wherein the location is simply taken as being in proximity to the RF beacon.
   iii Physical Location using the base-station. In the case where no RF beacons are reported, then the location of the base-station is used as the approximate location of the badge. For those embodiments, however, that lack the IR beacons 12, the hierarchy of priority will start with item (ii) above downward, wherein only the RF beacon data is used.

In case information from two IR beacons 12 is reported establishing two respective symbolic locations; one in proximity to a ‘logged-in’ workstation and another to a neighboring workstation, the neighboring workstation is then ignored for access purposes. Conversely, if the neighboring workstation ID is reported and the logged-in workstation ID is not reported, then the user is recognized as having moved and accordingly an action is initiated to adjust logged-in/out states.

In the case where certain actions (e.g. logon to a networked computer in front of which the badge has been located) may be initiated by the determination by the central unit 70 of the location of the badge 30, the central unit 70 will attempt to authenticate who originated the badge and base-station messages by sending a cryptographic authenticity challenge to the badge 30. The authenticity challenge is a large number (128 bits in length), which is randomly selected by the central unit 70 and stored in the database thereof along with a timestamp. When received, such authenticity challenge is encrypted by the recipient's cryptographic AES key and the result is partially sent back (e.g. the 64 least significant bits) as a ‘signature’ response to the central unit 70, for authentication by using the recipient's key to reproduce the challenge response, and verify if the badge 30 does possess the assigned AES key. Such an authentication scheme from the central unit 70 provides a definitive freshness indication by allowing the central unit 70 to time out the response after a suitable interval to disallow granting badge or base-station privileges.

Following the optional authenticity and freshness checks, the central unit 70 then sends back instructions to the badge 30 the location of which has been estimated, to achieve a set of functions and if necessary modify the badge's behaviour, by using a set of roles and privileges assigned to the badge's user and the estimated badge location, and any bindings of applications or data to that location (such as logon to a workstation, or indicating proximity to a patient via a beacon to bed to patient binding), relationship to other badge addresses, and any reading of the RFID tag reader 42. The binding criteria are software programmed into the central unit 70 and are possible to be dynamically modified depending on the overall status of the monitoring system 100, e.g. whether being in an emergency, within or outside working hours, etc.

The location estimation performed by the central unit 70 is useful in several applications of the present invention including the following examples.
A. Physical location is plotted on a map, e.g. as an x-y pair of coordinates.
B. Symbolic location is presented in one of different forms such as text, speech rendered by a text-to-speech algorithm and sent back to a user's badge 30.
C. The estimation is used in conjunction with the badge address to modify the behavior of the monitoring system 100 by contextualizing the interaction of location estimation data. For example, a surgeon before entering an operating theater leaves the badge thereof on a shelf illuminated by one of the IR beacons, a context is set for the badge that the surgeon is in surgery, and any messages redirected to another pre-designated location, until the surgeon picks up the badge, thereby automatically getting normal services again, and possibly evoking the reception of a message indicating the number missed messages.
As a further example, badge buttons automatically become alarm buttons after a nurse exits a safe area (e.g. upon entering a parking garage).
D. Providing a door access function with the use of a door IR beacon 12 having a relatively wide radiation envelope, but with relatively short range. This allows any badge 30 approaching from any direction to see the door IR beacon 12 and report this to the central unit 70 for processing, while minimizing ‘false events’ from the other badges 30 in the room. Once, the central unit 70 has authenticated the badge 30 and granted access, the central unit 70 sends a command to a door control system (as part of a security infrastructure) to allow the granted access. Alternatively, a door controller badge 30 having an actuator is used for controlling the door (e.g. opening, closing, locking, etc.) and for receiving a ‘door-open’ command from the neighboring base-station directly over the RF network 20. The door-access badge 30 then checks the command for authenticity and freshness before activating a door opening mechanism.
Furthermore, the door controller badge 30 is optionally provided with a sensor for sensing the door state (e.g. open, closed, locked, unlocked, etc) and for transmitting the door states to the central unit through the RF network 20 for processing as an event and then performing any one of related functions such as displaying an alert message on a console or map, generating a voice message, an E-mail, a pager message, or even an SMS to a cellular phone.
E. Providing a workstation access function controlled by a workstation IR beacon 12 having an IR radiation cone in front a computer workstation. This provides IR coverage to the area where a workstation user would normally be located, say a cone 120 degrees wide with a range of about 2 meters. The cone is adjustable both in terms of angle and range and narrower versions will provide isolation from adjacent workstations in areas populated with a high density of workstations. In the instance of the badge 30 seeing and reporting the workstation IR beacon 12, the central unit 70 is in a position to issue an event that starts the logon process for that workstation for the person carrying the badge 30. Once logged in, the session remains open so long as the badge 30 sees the correct IR beacon ID. Any other IR beacon IDs seen by the badge 30 are ignored. However, if one of the other badges 30, carried by another person approaching the same workstation, receives the IR beacon ID, such event is logged into the central unit 70 and the person is possibly notified of being approached by an observer. Once the badge 30 of the logged-in person stops seeing the workstation IR beacon 12, the central unit 70 is in a position to issue a command to disable workstation access by logging the user off or temporarily blanking the screen until the logged-in person returns within a programmable time period, after which the central unit will log out the user and enforce a new login requirement.
F. Providing a ‘role-based access’ function, wherein each user of the monitoring system 100 is given a certain set of roles associated with privileges to gain permissions for certain actions, such as ‘open a door’, ‘raise a parking gate’, or ‘login to a networked workstation’. The badge messages sent to the central unit 70 are treated as access events, to elicit respective responses defined by associations in the central unit database. Since all access events interact live with the central unit database, any database changes are instantly reflected in the operation of the entire system. If any one of the badges 30 is reported compromised for instance, this badge 30 is immediately de-activated to cancel the roles and privileges thereof and thereby cause an immediate workstation logoff or immediate removal of door access privileges for the user carrying the deactivated badge. In other words, the access events trigger the central unit 70 to authenticate the access transaction against the database thereof, similar to what is done in a typical query-response type system, for enhanced security control.
G. Another example of a binding application of the present invention is a healthcare application making use of the RFID tag reader 42, wherein medications are to be administered to a patient. A nurse carrying a badge that is bound to nursing roles and privileges is about to administer a medication to a patient, who is in an area flooded with IR beacon signals that indicate the nurse being in proximity to the patient bed. In case, the patient is wearing a passive RFID wristband, and the medication is tagged with an RFID tag, it will be possible to ensure that administration of medication is correct, by verifying the following indicators:
   Length of elapsed time since the medication was previously administered.
   Patient identity obtained from the patient's RFID tag.
   Patient location established by receiving the current IR beacon ID at the nurse's badge.
   Type of medication read from the medication RFID tag.
   Privilege of the nurse identified by the nurse's badge to administer the particular medication to the particular patient.
The above indicators are then transferred to a clinical system associated with the central unit to check if the administering the medication is appropriate, and to inform the nurse's badge accordingly. Once the medication has been administered, the nurse sends a message to a clinical system application linked to the central unit 70 via the nurse's badge indicating successful administration, so that the clinical system will update a database thereof. Otherwise, if there were an error in any one of the above indicators, the nurse's badge would receive a message from the clinical system to stop administering the medication. This arrangement provides a last-minute check against the clinical system database for crosschecking patient and drug information to prevent administration of improper medications. The same arrangement is also suitable for tracking blood bags, IV bags, etc., which are treated in a similar way to medications.
H. Providing a visitor's guidance service, wherein a detailed list of path segments is uploaded to the flash memory unit 36 of the badge 30 to guide a visitor from a current location towards a desired location within a facility covered by the monitoring system 100. As the visitor moves around the facility, the badge 30 detects the nearby IR beacons 12 and issues real time navigational instructions using the path segment details and generating the instructions from canned voice words stored in the flash memory unit 36. The badge 30 will also detect when the visitor wanders off course and request the central unit 70 to provide a new path to guide the visitor to the desired destination.
I. Infant protection is provided, when using two types of the RF beacons 11 in the monitoring system 100; stationary beacons and low-power portable beacons worn by designated users. The infant wears one badge 30, and the designated persons such as infant's parents, nurses, specialists, visitors, etc. wear the portable beacons. Infants are considered to be ‘safe’ if they are in either a ‘safe location’ defined by a specified subset of the stationary beacons, or a ‘safe custody’ defined by a specified subset of the portable beacons. The infant badge 30 will periodically scan for those stationary and portable beacons that are identified by the central unit 70 along with corresponding RSSI threshold values as being safe for the particular infant badge 30. The infant badge 30 then monitors its own condition and sends a badge message to the central unit 70 whenever detecting a status change in the received beacon messages, and an alarm is generated, whenever the infant is considered to be ‘unsafely’ located. The use of a secure two-way RF badge 30 for infants, allows for the prevention of unauthorized persons from removing the infant from the safe location, by using another device to emulate the badge 30 as well as disabling any previously activated infant badge 30 to permit removal of the infant badge 30, and moving the infant out of a building without detection. The ability to strongly authenticate badges over the two-way RF network 20 prevents replay of the badge's responses and thus ‘cloning’ of the badge 30.

The central unit 70 uses an SQL based database to tabulate all the information necessary to manage the system. The database is stratified in three distinct layers; a first layer with a fully relational system, then a second layer with a series of fast access tables containing data abstracted from the relational system, and a third layer with a series of very fast in-memory tables for network addressing. In this layering structure, data integrity and transactional integrity are used for the less frequently changed elements of the system, scalability for the system is provided by a relatively fast direct retrieval and update mechanism for the faster changing elements, and both high reliability operation and fault tolerance are obtained from a simplified cluster-based in-memory system. The central unit 70 provides graphical tools to simplify operators' tasks for administering and modifying the access roles and privileges associated with the badges as mentioned above. Dynamic maps are provided to display the location of each badge as well as key status information such the state of doors (open or closed).

Typically only a subset of all the RF channels is active at any given site due to interference and general local RF environment. To keep track of which of the RF channels are suitable for use at any given site, the central unit 70 maintains a downloadable channel mask (128 bits=16 bytes) for every site and every control and data channel type. This is used for selectively turning the channels ‘on’ and ‘off’ to allow the RF network to minimize channel interference. The channel mask is also provided to the badges 30, to optimize the badge's search for a suitable base-station 50 to join by skipping over those channels that are not in use.

To generate the channel masks for any selected site, the central unit 70 firsts performs a local RF survey of the selected site by instructing every base-station 50 to scan all the nearby control and data channels in use, to record average, maximum and minimum RSSI per channel at the base-station 50 and then return such scanning results to the central unit 70. Once generated, the channel mask provides a list of clear channels available for use by the base-station 50 and the central unit 70 informs the base-station 50 of the most suitable channel to use as master control channel thereof. Furthermore, this process allows immediate identification of any local problem, whereas running this process for a few days will identify any problematic (e.g. noisy) channels to be avoided. This application allows the central unit 70 to acquire the RF spectrum from any base-station 50 for routing anywhere on the data network 10 for viewing. This application is used to carry out an RF survey of a facility prior to and during installation of the monitoring system 100 as well as to check for interference problems during normal running.

The monitoring system 100 is centrally administered, wherein the administrative applications are used to enrol new users with assigned badges 30 and respective roles. Any removal of a role from a user will immediately disable any privileges that the user had acquired from that role, for example by making the badge 30 inactive for access while the monitoring system 100 will still detect which badges 30 are joining which base-stations 50 thereby still finding the location of the inactivated badge 30, and being in a position to generate an alert whenever such an inactivated badge shows up on the monitoring system 100.

Typically, there is one central unit 70 per installation, but the present invention does allow for more than one federating central units cooperating with one another while performing some or all of the functions described above. For such operation, the channel masks are used for efficient joining but the badges 30 will always fall back to a full search of all the possible base-stations 50 so a ‘foreign’ badge is always able to find and to join one of the base-stations 50, and will then be sent a configuration packet which contains the current channel mask in use. The central unit 70 receives and checks the badge address for being registered therein. If not, the central unit 70 will send a query to other federated central units to find if the badge 30 is registered anywhere, in order for the badge 30 to be authenticated and given privileges on the network.

In an alternative embodiment, the monitoring system 100 further includes a number of portable RF tags; each assigned a unique tag ID known to the central unit 70. Each tag periodically transmits a ‘ping’ containing the tag ID, over tag RF channels (centered at 303, 433 and 902-928 MHz) in a channel-friendly way. The base-station 50 is provided with at least one frequency-adjustable tag reader coupled to a separate tag antenna for listening to the tag IDs. The base-station 50 accumulates tag data consisting of the tag IDs and corresponding RSSI values for transmission to the central unit 70, which in turn processes the tag data to estimate the tag location based on the RSSI values and intersection of range circles from the reporting base-stations. The choice of tag RF channels is adjustable to allow compatibility with the RF network 20.

Priorities for the tag-based location estimation are then as follows.
i) Using signal strength calculations when at least two base-stations 50 report hearing the tag; and
ii) Using proximity when only one base-station 50 reports hearing the tag.

There are two kinds of tags, passive tags that respond only when queried, and active tags that broadcast the ping periodically. One critical issue for all tag systems is to ensure that the tag readers are able to hear each tag separately, otherwise information gets lost in collisions. Each passive tag must respond to only one base-station within a facility, in order to avoid collisions. This limits the placement of base-stations and restricts the location estimation precision to that of a ‘proximity’ to a base-station. For the active tags, there are many base-stations that hear the tag pinging and this will increase the precision of the location estimation.

The problem of collisions imposes a maximum density on the tags in any area. The following are examples of strategies for increasing density of tags while still maintaining a reasonably low rate of collisions.
a) Increase the tag data rate to shorten the ping duration thereby reducing collisions, but at the expense of reduced sensitivity and increased interference.
b) Reduce the tag transmit power to avoid collision with tags further away to decrease the area to be considered, but at the expense of increasing the number of base-stations.
c) Provide the tags with collision avoidance to enable listening on the RF channel to check if the channel was clear before pinging. This will reduce the chances of collision significantly, since only the tags that start to transmit really within a small window of time are likely to clobber one another. Thus tag density is increased at the expense of increasing the tag complexity with a more powerful processor and the ability to receive as well as transmit. The extra listening periods will also require more battery power.
d) Use multiple RF channels randomly assigned to the tags.
e) Use a mixture of normal tags and Collision Avoiding (CA) tags, wherein the normal tags operate only on a first channel and ping randomly, whereas the CA tags use a second channel whenever the first channel is too busy. The CA tags determine when this occurs by listening before talking and measuring the density of tags using the first channel. The second channel is reserved for the CA tags to allow for efficient channel use.

Optionally, the tag includes additional components such as a battery meter, a pushbutton, a motion sensor to increase the ping rate when motion is detected, a pressure sensor to determine, for example, if a wheelchair is occupied, etc. Accordingly, the ping will contain additional data reflecting the status for such additional tag components.

One refinement of this embodiment is to program the base-stations 50 to keep a list of tags and the corresponding RSSI values and send a base-station message to the central unit 70 only when a significant change to the list occurs, i.e. hearing a new tag, loss of an existing tag or a substantial change to a tag's RSSI. This is to reduce network traffic and computation overhead at the central unit 70, but at the expense of additional base-station memory and computation.

The above-described embodiments are intended to be examples of the present invention. Numerous variations, modifications, and adaptations may be made to the particular embodiments by those of skill in the art, without departing from the spirit and scope of the invention, which are defined solely by the claims appended hereto.

We claim:

1. A two-way wireless monitoring system for tracking the location of a badged user or a badged object within a facility, the monitoring system comprising:
a plurality of beacons bearing unique beacon IDs thereof, distributed throughout the facility for periodically broadcasting over a wireless medium respective beacon messages carrying the respective beacon IDs;
a portable badge having a unique badge address, for picking up from the wireless medium the beacon messages of nearby beacons;
a base-station comprising an RF transceiver for establishing an RF link with the badge when being within an RF coverage range of the base-station; and
a central unit accessible by the base-station via a data network,
wherein, in operation, the badge composes a badge message containing the beacon IDs of the nearby beacons;
wherein the base-station frequently polls, via the established RF link, the badge to receive the badge message therefrom;
wherein the base-station uploads a base-station message, containing the badge address and the badge message, to the central unit via the data network; and
wherein the central unit estimates the badge location using the base-station message and decides on triggering an event within the facility based on the badge address and the estimated badge location.

2. The monitoring system of claim 1, further comprising a network manager for multiplexing and demultiplexing traffic between the base-station and the data network.

3. The monitoring system of claim 1,
wherein the plurality of beacons include a radio frequency (RF) beacon;
wherein the badge comprises means for measuring received signal strength intensity (RSSI) value of the beacon message of the RF beacon; and
wherein said RSSI value is included in the badge message.

4. The monitoring system of claim 1,
wherein the plurality of beacons include an infrared (IR) beacon;
wherein the badges comprises an IR receiver for picking the beacon messages of the IR beacon; and
wherein the badge message includes information on changes in the IR beacons detected by the badge since sending most recent badge message.

5. The monitoring system of claim 4, wherein the IR beacon comprises means for generating a power-adjusted and optically shaped broadcast envelope to define a coverage range for the IR beacon.

6. The monitoring system of claim 4, wherein the IR beacon comprises a light sensor for stabilizing the IR beacon coverage range by adjusting the IR beacon emission power to compensate for ambient light levels.

7. The monitoring system of claim 4,
wherein the IR beacon comprises means for sequentially adjusting emission of the IR beacon to more than one power level; and
wherein the beacon ID is distinctly different for each power level.

8. The monitoring system of claim 1, wherein the badge and the base-station are respectively assigned unique cryptographic keys for use in:
authenticating the badge address and the badge messages to and from the central unit;
encrypting transmitted messages; and
checking freshness and integrity of received messages.

9. The monitoring system of claim 1,
wherein the RF link includes a narrowband RF control channel and a wideband RF data channel;
wherein the badge further comprises a badge processor; and
wherein the RF badge transceiver is selectively switchable between the RF control channel and the RF data channel under control of the badge processor.

10. The monitoring system of claim 9, wherein the badge further comprises:
a flash memory unit linked to the badge processor for bulk storage of received messages and messages awaiting transmission; and
a programmable interface for transferring data between the badge processor and the RF badge transceiver.

11. The monitoring system of claim 9, wherein the badge comprises a user interface linked to the badge processor, the user interface including a component selected from the group consisting of:
an audio codec and a speaker-microphone pair controlled thereby;
an RFID tag reader for reading passive RFID tags;
a piezoelectric buzzer for alerting the user;
an LED display, for indicating status of the badge;
a set of pushbutton switches, for activation by the user;
a motion sensor;
a serial I/O port; and
a proximity sensor having single I/O pin on the badge processor for detecting proximity of a body part of the user by a change in the pin's capacitance.

12. The monitoring system of claim 9, wherein the base-station (BS) comprises:
a first transceiver for the control channel;
a second transceiver for the data channel;
a data network interface;
a BS processor communicating with the data network interface, the first and second transceivers;
a BS antenna; and
a SAW duplexer linked to the first and second transceivers and the BS antenna, for feeding the antenna with combined signals from the first and second transceivers, while providing mutual isolation between the first and second transceivers.

13. The monitoring system of claim 1, wherein the plurality of beacons include a plurality of stationary beacons and a portable beacon for being worn by a designated person, such that the user is considered to be ‘safe’ when being in one of a ‘safe location’ defined by a specified subset of the plurality of stationary beacons, and a ‘safe custody’ defined by the portable beacon.

14. The monitoring system of claim 1, further including an RF tag, bearing a unique tag ID, for periodically broadcasting an RF ‘ping’ carrying the tag ID;
wherein the base-station includes a frequency-adjustable tag reader coupled to a tag antenna for receiving the ‘ping’, and means for measuring received signal strength intensity (RSSI) value of the received ‘ping’; and
wherein, in operation, the base-station uploads the tag ID and the RSSI value to the central unit for use in estimating the tag location.

15. The monitoring system of claim 14, wherein the tag comprises a motion sensor to increase the ping rate when motion is sensed.

16. A method for tracking the location of a badged user or a badged object within a facility, the method comprising the steps of:
(a) providing a plurality of beacons throughout the facility, each of which periodically broadcasts over a wireless medium a beacon message, carrying a corresponding beacon ID;
(b) providing a portable badge having a badge address for picking up from the wireless medium the beacon messages within the coverage area thereof, and for composing a badge message containing the respective beacon IDs;
(c) transferring the badge message to a central unit over an RF network, at a predetermined polling frequency;
(d) estimating the badge location by the central unit, using the badge message; and
(e) triggering an event within the facility, based on the badge address and the estimated badge location.

17. The method of claim 16,
wherein the wireless medium is an RF medium; and
wherein the badge message further includes measured RSSI values corresponding to the beacon messages picked up by the badge.

18. The method of claim 16,
wherein the wireless medium is an IR medium of a power-adjusted and optically shaped broadcast envelope to define a specific coverage range; and
wherein the badge message further includes information on changes in the beacons detected by the badge since sending most recent badge message.

19. The method of claim 16, wherein the event triggered by central unit is one of the group consisting of allowing a secured access to a specific area within the facility, data transfer, paging, voice and data messaging, authentication, providing infant security, and delivering local navigational guidance.

20. The method of claim 16, wherein in step (b) the badge compiles and monitors a beacon data table of all the picked up beacons, to detect any change in the badge location.

21. The method of claim 16,
wherein step (c) is performed by a base-station; which attempts to establish a network link to the central unit;
wherein said base-station is dynamically configured as a gateway when successful, and self-configured as a router when unsuccessful; and
wherein the router seeks to establish the data network link via another base-station configured as a gateway.

22. The method of claim 16, wherein step (d) includes:
maintaining a beacon record of location and coverage area associated with each beacon ID; and
performing an analysis of the received badge message against said beacon record for use in estimating the badge location.
